(19) United States
(12) Patent Application Publication
(10) Pub. No.: US 2018/0056910 A1
(43) Pub. Date: Mar. 1, 2018

(54) COVER FOR SMART-CRUISE-CONTROL RADAR

(71) Applicants: Hyundai Motor Company, Seoul (KR); Kia Motors Corp., Seoul (KR)

(72) Inventors: Seung Chan HONG, Anseong-si (KR); Byung Kyu CHO, Seoul (KR); So Jung SHIM, Seoul (KR)

(73) Assignees: Hyundai Motor Company, Seoul (KR); Kia Motors Corp., Seoul (KR)

(21) Appl. No.: 15/367,102

(22) Filed: Dec. 1, 2016

(30) Foreign Application Priority Data
Aug. 29, 2016 (KR) 10-2016-0110001

(51) Int. Cl. B60R 19/52; B32B 15/04

(52) U.S. Cl. CPC B60R 19/52; B60R 19/483; B32B 15/04

(57) ABSTRACT

A cover for a smart-cruise-control radar, which is mounted to a radiator grill of a vehicle may include a transparent first layer, a rear surface of which is divided into a curved portion formed at a position corresponding to a metallic portion of the radiator grill, a flat portion formed at a position corresponding to a void in the radiator grill, and a stepped portion formed between the curved portion and the flat portion, thus having a bent shape, an opaque second layer, a front surface of which has a shape corresponding to the rear surface of the first layer; a metallic-textured layer formed between the first layer and the second layer, and a painted layer formed on the flat portion between the first layer and the metallic-textured layer.

### CROSS-REFERENCE TO RELATED APPLICATION

The present application claims priority to Korean Patent Application No. 10-2016-0110001, filed on Aug. 29, 2016, in the Korean Intellectual Property Office, the entire contents of which is incorporated herein for all purposes by this reference.

### BACKGROUND OF THE INVENTION

### Field of the Invention

The present invention relates to a cover for a smart-cruise-control radar, and more particularly, to a cover for a smart-cruise-control radar, which is installed to a radiator grill of a vehicle.

### Description of Related Art

Generally, a radar for smart cruise control (hereinafter also referred to as an “SCC”), which is applied to a vehicle, is installed on the rear area of a vehicle radiator.

However, because a radiator grill is manufactured of metal and may intercept transmitted or received radio waves, a cover for protecting the radar for SCC is installed at the front of the radar in an area from which the radiator grill is removed.

The cover is not made of a metal material in order to improve the transmittance of radio waves. A plastic cover, which is painted black without any particular pattern, is typically used.

However, when such a simply manufactured cover is used, the metallic area of the radiator grill is discontinuous at the position at which the cover is installed, which deteriorates the outward aesthetic appearance of the radiator grill.

Therefore, there is a demand for a novel cover material or structure that does not deteriorate the transmittance of radio waves and may reflect light in the same manner as a metal, i.e. the metallic area of the radiator grill.

As one attempt for this, a technology has been developed by which an optical film, which is manufactured by alternately stacking ceramic films having different indices of refraction one above another, is installed to the cover so as to reflect light in the same manner as a metallic grill.

The optical film manufactured from the multi-layered ceramic films has the feature by which it may realize reflected light like that from a metal, i.e. reflected light having little variation in reflectivity within a visible light range while maintaining high radio wave transmittance.

Conventionally, it has been attempted to form such an optical film so as to be contiguous in shape with the surrounding grill and to form black screen areas, which are connected to voids in the grill, above and below the optical film so that the external appearance of the cover coincides with the grill.

In FIG. 1A is a photograph of a cover, to which an optical film, which is manufactured in the same shape as a surrounding grill, is applied. In addition, FIGS. 2 to 4 are respectively an exploded sectional view and sectional views illustrating a conventional cover.

As illustrated, a black reflective area B appears above a grill-shaped portion of the cover, i.e. a curved portion 100, which causes a metallic-textured area of the optical film to appear narrow. Although a metallic-textured layer 40, i.e. the optical film is formed in practice in the black reflective area B, a black painted layer 30 above the area B is reflected in the metallic-textured layer 40, thus causing the metallic-textured layer 40 to appear black. Thereby, the grill-shaped portion, represented by the metallic-textured layer 40, looks narrower than the actual metallic portion of the grill G.

Therefore, in order to prevent the problem described above, a novel cover, which may exhibit a form similar to an actual grill, is required.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a cover for a smart-cruise-control radar, which may exhibit continuance in design with an actual radiator grill.

In accordance with an aspect of the present invention, the above and other objects can be accomplished by the provision of a cover for a smart-cruise-control radar, which is mounted to a radiator grill of a vehicle, the cover including a transparent first layer, a rear surface of which is divided into a curved portion formed at a position corresponding to a metallic portion of the radiator grill, a flat portion formed at a position corresponding to a void in the radiator grill, and a stepped portion formed between the curved portion and the flat portion, thus having a bent shape, an opaque second layer, a front surface of which has a shape corresponding to the rear surface of the first layer, a metallic-textured layer formed between the first layer and the second layer, and a painted layer formed on the flat portion between the first layer and the metallic-textured layer.

The flat portion may have an angle within a range from 45 degrees to 85 degrees relative to a front-and-rear direction of the vehicle, and the stepped portion may have an angle, defined by Equation 1, relative to the front-and-rear direction of the vehicle:

Y=(X−45)/2 Equation 1

where, Y is the angle between the stepped portion and the front-and-rear direction of the vehicle, and X is the angle between the flat portion and the front-and-rear direction of the vehicle.

The stepped portion may be formed to allow an end portion of the curved portion and an end portion of the flat portion, which are adjacent to each other, to be spaced apart from each other by a distance within a range from 0.32 mm to 3.00 mm.

The stepped portion may be formed to allow the curved portion and the flat portion, which are adjacent to each other, to be spaced apart from each other by a distance within a range from 0.30 mm to 3.00 mm in the front-and-rear direction of the vehicle.

The stepped portion may be formed to allow the curved portion and the flat portion, which are adjacent to each other, to be spaced apart from each other by a distance within a range from 0.00 mm to 1.03 mm in a vertical direction of the vehicle.

The stepped portion may be formed to have any one cross-sectional shape selected among linear, curvilinear, toothed, and stepped cross-sectional shapes.

The curved portion may be elongated in a width direction of the vehicle, and the stepped portion may be formed to come into contact with an upper end portion of the curved portion.

The metallic-textured layer may be an optical film having TiO₂ and SiO₂ alternately stacked one above another.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A and FIG. 1B illustrate photographs comparing the shapes of a conventional SCC cover and an SCC cover according to an exemplary embodiment of the present invention with each other;

FIG. 2 is an exploded sectional view of the conventional SCC cover;

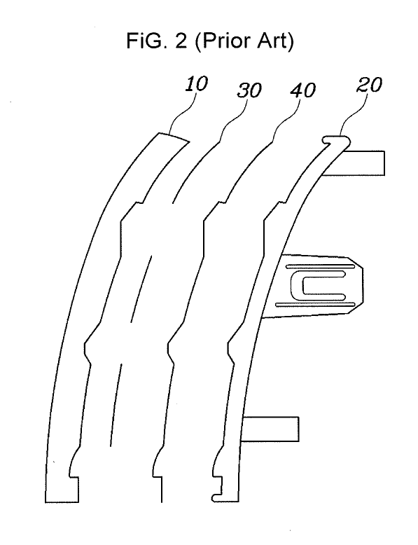

FIG. 3 is a sectional view of the conventional SCC cover;

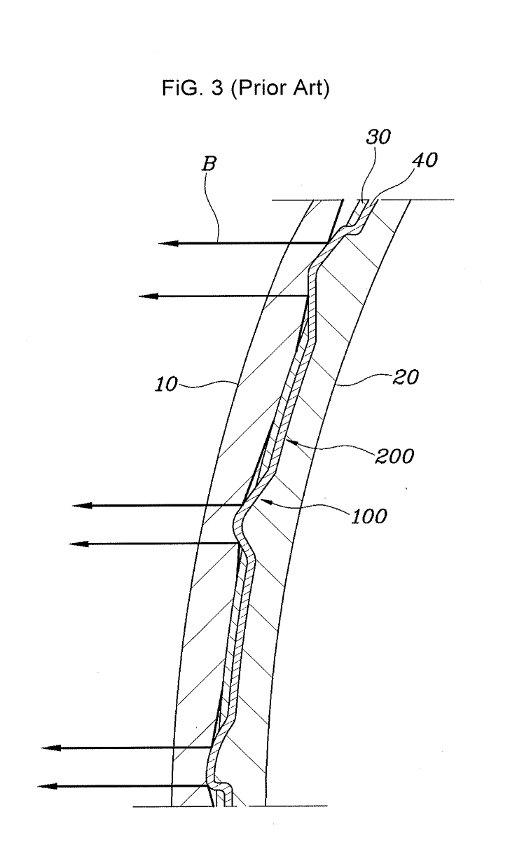

FIG. 4 is an enlarged sectional view illustrating the periphery of a curved portion of the conventional SCC cover;

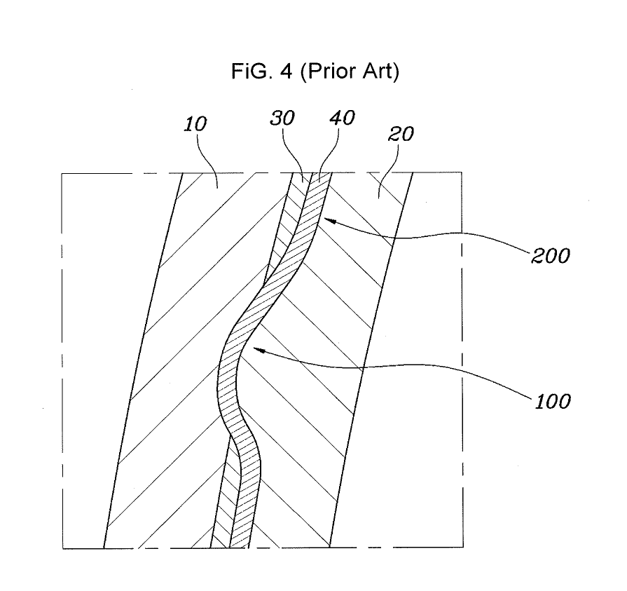

FIG. 5 is an enlarged sectional view illustrating the periphery of a curved portion of the SCC cover according to the exemplary embodiment of the present invention;

FIG. 6 is a schematic view illustrating the relationship between the installation angles of a stepped portion and a flat portion of the SCC cover according to the exemplary embodiment of the present invention; and

FIG. 7 is a schematic view illustrating a person overlooking the SCC cover according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, a cover for a smart-cruise-control radar according to an exemplary embodiment of the present invention will be described with reference to the accompanying drawings.

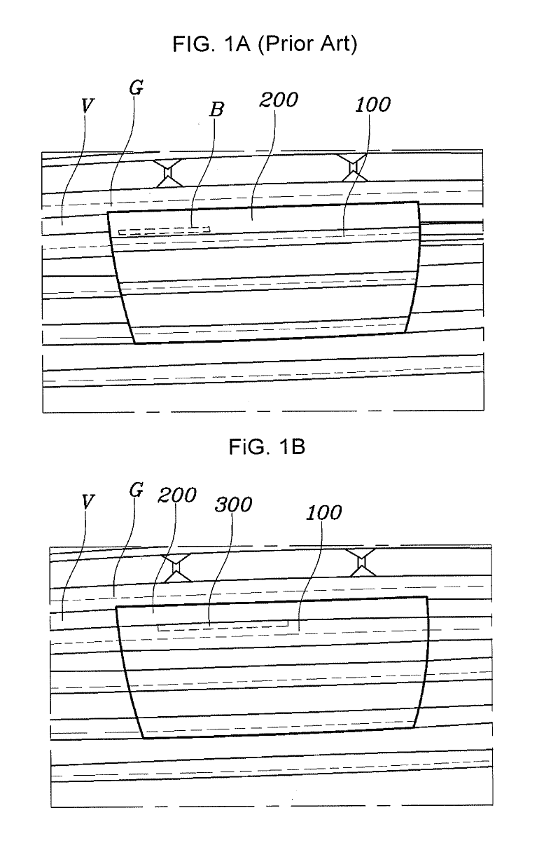

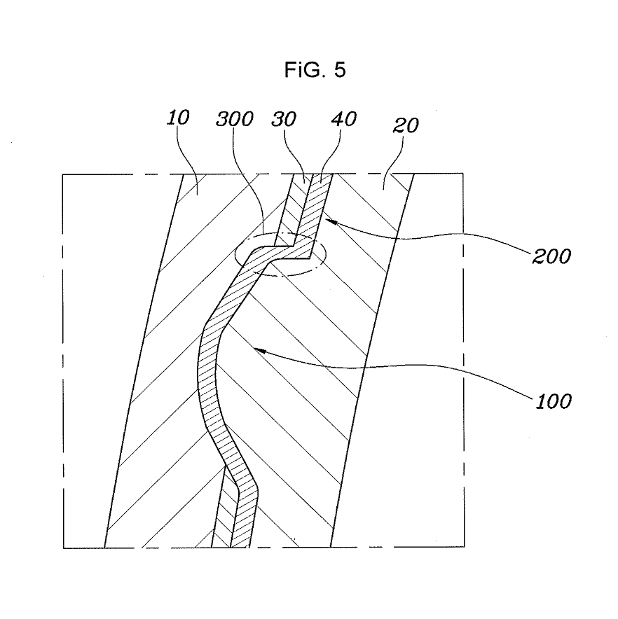

As illustrated in FIGS. 1 and 5, the cover according to an exemplary embodiment of the present invention broadly includes a transparent first layer 10, an opaque second layer 20, a metallic-textured layer 40 that reflects light like metal, and a painted layer 30 that covers a position on the metallic-textured layer 40.

Here, each of the rear surface of the first layer 10 and the front surface of the second layer 20 is divided into a curved portion 100, a flat portion 200, and a stepped portion 300, thus having a bent shape. Through the metallic-textured layer 40 formed between the first layer 10 and the second layer 20, reflected light, which looks like light reflected from a metallic radiator grill, may be realized.

The first layer 10 may be formed of a transparent polycarbonate (PC) material in consideration of transparency and radio wave transmittance. in an exemplary embodiment of the present invention, because the metallic-textured layer 40 needs to exhibit the shape of a metallic portion G of the radiator grill at a designated position, the first layer 10 may be formed of a PC material that has a low index of refraction.

The front surface of the first layer 10 is relatively smooth. The front surface of the first layer 10 may be curved to form an imaginary grill surface that connects discrete metallic portions G of the radiator grill.

The rear surface of the first layer 10 has a bent shape in which the curved portion 100 for representing the shape of the metallic portion G of the radiator grill, the flat portion 200 for representing the shape of a void V in the radiator grill, and the stepped portion 300 for connecting the curved portion 100 and the flat portion 200 to each other and preventing black reflected light from appearing in the curved portion 100 are alternately arranged.

Explaining the above-described structure in more detail, the curved portion 100 is recessed in the rear surface of the first layer 10 to protrude forward from the first layer 10 in the same form as the metallic portion G of the radiator grill. The curved portion 100 is located on the same line as the metallic portion G of the actual radiator grill.

The flat portion 200 is located on the same line as the void V in the radiator grill. The painted layer 30, which will be described later, is formed on the flat portion 200 of the first layer 10 to represent the shape of the void V in the radiator grill.

In the same manner as the actual radiator grill in which the metallic portion G and the void V are alternately arranged, the curved portion 100 and the flat portion 200 are alternately formed to show the shape of the radiator grill.

The stepped portion 300 is formed between the curved portion 100 and the flat portion 200 and serves as a buffer zone, which prevents reflected light from being directly introduced between the two portions 100 and 200.

The role of the stepped portion 300 and the principle of preventing the reflection of light thereof will be described later in more detail.

The second layer 20 is injection-molded on the rear surface of the first layer 10 so that the front surface thereof has a shape corresponding to the shape of the rear surface of the first layer 10. In consideration of the ability to mix with a black material, such as, for example, carbon black, injection-molding processibility, and the like, the second layer 20 may be formed of an acrylonitrile ethylene styrene (AES) resin.

The second layer 20 is manufactured as an opaque layer and suppresses the transmission of outside light introduced through the first layer 10. However, the second layer 20 is configured to transmit almost all radio waves within an SCC radar range, which is different from a visible light range.

The metallic-textured layer 40 is an optical film in which two ceramic layers, having different indices of refraction, are alternately arranged as described above in the Description of Related art. In one example, an optical film in which TiO₂ and SiO₂ are alternately deposited may be used.

The metallic-textured layer 40 is formed on the rear surface of the first layer 10 and exhibits a metallic texture like the metallic portion G of the radiator grill by reflecting outside light introduced through the first layer 10. At this time, when the second layer 20 is opaque as described above, the metallic-textured layer 40 may achieve increased reflectivity, which may result in brighter reflected light.

In addition, an opaque-painted layer may be additionally provided between the metallic-textured layer 40 and the second layer 20 to further increase the reflectivity of the metallic-textured layer 40.

The painted layer 30 is formed of a black paint and serves to cover a portion of the area of the metallic-textured layer 40. The painted layer 30 is formed to cover the flat portion 200 on the rear surface of the first layer 10. Because the flat portion 200 serves to represent the void V in the radiator grill, the flat portion 200 may be realized with a matte paint that may suppress the reflection of light.

Hereinafter, the principle whereby the metallic portion G and the void V of the radiator grill are clearly represented by controlling the detailed shapes, the coupling relationship, and the angles of reflected light of the curved portion 100, the flat portion 200, and the stepped portion 300 will be described.

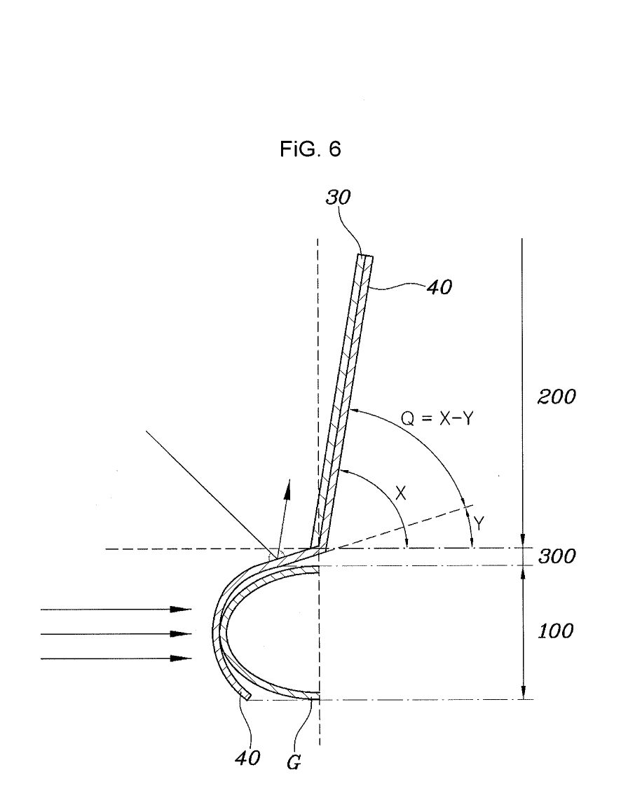

As illustrated in FIG. 6, the curved portion 100 has the same height, i.e. the length in the vertical direction of the drawing, as the metallic portion G of the grill. Although the curved portion 100 and the metallic portion G have conventionally been formed to have the same shape, as described above, the black reflective area is formed, which reduces the area of the curved portion 100 that exhibits a metallic texture. Therefore, in an exemplary embodiment of the present invention, the curved portion 100 is formed such that the length thereof in the front-and-rear direction, i.e. the length thereof in the left-and-right direction of the drawing, is shorter than that of the metallic portion G, and the stepped portion 300 is formed separately to compensate for this difference in length.

At this time, the flat portion 200 may be basically formed to be inclined at an angle of 45 degrees to 85 degrees relative to the horizontal plane of the vehicle in the front-and-rear direction. This angular range is based on the angle at which the radiator grill is actually mounted in a vehicle. When the angle at which the flat portion 200 is mounted deviates from the above angular range, the resulting cover may appear distinct from the radiator grill.

TABLE 1

| Flat portion | 90 | 85 | 80 | 75 | 70 | 65 | 60 | 55 | 50 | 45 | 40 |
|---|---|---|---|---|---|---|---|---|---|---|---|
| X(°) | | | | | | | | | | | |
| Stepped | 22.5 | 20.0 | 17.5 | 15.0 | 12.5 | 10.0 | 7.5 | 5.5 | 2.5 | 0.0 | −2.5 |
| portion | | | | | | | | | | | |
| Y(°) | | | | | | | | | | | |
| Stepped | 3.00 | | | | | | | | | | |
| length(mm) | | | | | | | | | | | |
| Front-and- | 2.77 | 2.82 | 2.86 | 2.90 | 2.93 | 2.95 | 2.97 | 2.99 | 3.00 | 3.00 | 3.00 |
| rear | | | | | | | | | | | |
| difference | | | | | | | | | | | |
| (mm) | | | | | | | | | | | |
| Vertical | 1.15 | 1.03 | 0.90 | 0.78 | 0.65 | 0.52 | 0.39 | 0.26 | 0.13 | 0.00 | 1.11 |
| difference | | | | | | | | | | | |
| (mm) | | | | | | | | | | | |
| Stepped | 0.32 | | | | | | | | | | |
| length(mm) | | | | | | | | | | | |
| Front-and- | 0.30 | 0.30 | 0.31 | 0.31 | 0.31 | 0.32 | 0.32 | 0.32 | 0.32 | 0.32 | 0.32 |
| rear | | | | | | | | | | | |
| difference | | | | | | | | | | | |
| (mm) | | | | | | | | | | | |
| Vertical | 0.12 | 0.11 | 0.10 | 0.08 | 0.07 | 0.06 | 0.04 | 0.03 | 0.01 | 0.00 | −0.01 |
| difference | | | | | | | | | | | |
| (mm) | | | | | | | | | | | |

The angular relationship between the stepped portion 300 and the flat portion 200 illustrated in FIG. 6 is illustrated in Table 1.

As illustrated in FIG. 6 and Table 1, on the basis of the horizontal plane in the front-and-rear direction of the vehicle, i.e. in the left-and-right direction of the drawing, the angle Y between the stepped portion 300 and the horizontal plane is half of the value acquired by subtracting an observation angle of 45 degrees from the angle X between the flat portion 200 and the horizontal plane. At this time, the angle Q between the stepped portion 300 and the flat portion 200 is determined using X-Y in practice.

When the angle between the stepped portion 300 and the flat portion 200 is controlled as described above, light introduced at the angle of 45 degrees from the front side of the vehicle is reflected by the stepped portion 300, and thereafter progresses in the direction parallel to the flat portion 200. This is because the introduction angle (Y+45) and the reflection angle (Q=X−Y) with respect to the stepped portion 300 are the same. In summary, the following Equation 1, which shows the angular relationship between the stepped portion 300 and the flat portion 200, is derived.

Y=(X−45)/2 Equation 1

That is, when the stepped portion 300 is observed at an angle of 45 degrees relative to the horizontal plane, the stepped portion 300 may exhibit a metallic texture, rather than appearing black of the flat portion 200. However, because the viewing angle at which people observe the radiator grill is generally smaller than 45 degrees, the stepped portion 300 appears black under the condition of the smaller observation angle because the flat portion 200 is reflected in the stepped portion 300.

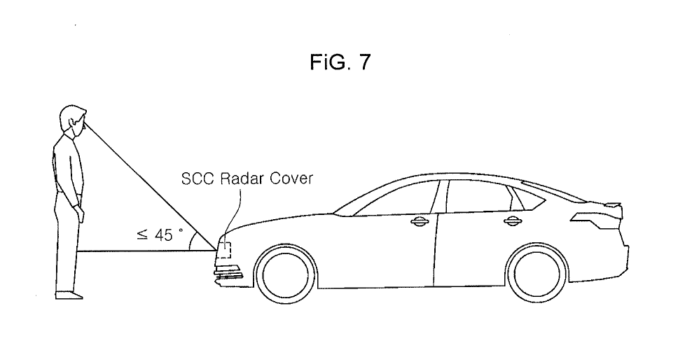

Because the flat portion 200 is reflected only in the stepped portion 300, but is not reflected in the curved portion 100, which is forwardly spaced apart from the flat portion 200, the entire curved portion 100 may reflect light in the same manner as metal. In addition, because the vertical length of the curved portion 100 is the same as the vertical length of the metallic portion G of the grill, when the curved portion 100 is observed in a general situation, i.e. as illustrated in FIGS. 6 and 7, at a viewing angle of 45 degrees or less, reflected light, which looks light reflected from a metal member having the same thickness as the metallic portion G of the radiator grill, may be observed.

At this time, the above-described effect may be achieved when the curved portion 100 and the flat portion 200 are spaced apart from each other by a predetermined distance. When the end portion of the curved portion 100 and the end portion of the flat portion 200 are spaced apart from each other by 0.30 mm or more in the front-and-rear direction, the black flat portion 200 is not reflected in the curved portion 100.

However, the distance in the front-and-rear direction may be limited to 3.00 mm or less because an excessively large distance may cause a difference in design.

When the net length of the stepped portion 300 between the end portion of the curved portion 100 and the end portion of the flat portion 200 is determined based on the distance in the front-and-rear direction, it ranges from 0.32 mm to 3.00 mm.

In addition, when the distance between the curved portion 100 and the flat portion 200 in the vertical direction is determined based on the aforementioned values, it ranges from 0.00 mm to 1.03 mm.

The stepped portion 300 may be formed in a plane shape, but may have a curved surface or a waved surface as needed. Even in the instant case, the length of the stepped portion 300 described above needs to be maintained. In the case where the stepped portion 300 is formed to have a curved surface, which continuously extends from the curved portion 100, whereby the curved portion 100 and the stepped portion 300 are not clearly distinguished from each other, a straight line, which connects the end portion of the flat portion 200 to the vertex of a first inflection point of the curved portion 100, needs to form an angle of 20 degrees or more with the flat portion 200.

Although the stepped portion 300 may be formed on each of upper and lower end portions of the curved portion 100, the stepped portion 300 may be mounted on the upper end portion of the curved portion 100 to prevent black reflected light from the flat portion 200 above the curved portion 100 from being reflected in the curved portion 100 because the viewing angle at which people observe the radiator grill has a positive value, in other words, because people observe the radiator grill from the upper side thereof. At this time, the stepped portion 300 may be added to the lower end portion of the curved portion 100 as needed.

As is apparent from the above description, a cover for a smart-cruise-control radar according to an exemplary embodiment of the present invention has the following effects.

First, an SCC cover, which includes a metallic-textured area, and thus exhibits continuance in design with a radiator grill, may be provided.

Second, the SCC cover is configured to prevent a black painted layer on a flat portion thereof from being reflected in a curved portion, which may prevent distortion in the shape of a radiator grill.

Third, the above-described effects may be accomplished by slightly changing a sectional structure of the cover, which ensures simplified application of the present invention.

Although the exemplary embodiments of the present invention have been described above with reference to the accompanying drawings, those skilled in the art will appreciate that the present invention can be implemented in various other embodiments without changing the technical ideas or features thereof.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “interior”, “exterior”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A cover for a smart-cruise-control radar, which is mounted to a radiator grill of a vehicle, the cover comprising:
a transparent first layer, a rear surface of which is divided into a curved portion formed at a position corresponding to a metallic portion of the radiator grill, a flat portion formed at a position corresponding to a void in the radiator grill, and a stepped portion formed between the curved portion and the flat portion, thus having a bent shape;
an opaque second layer, a front surface of which has a shape corresponding to the rear surface of the first layer;
a metallic-textured layer formed between the first layer and the second layer; and
a painted layer formed on the flat portion between the first layer and the metallic-textured layer.

2. The cover according to claim 1, wherein the flat portion has an angle within a range from 45 degrees to 85 degrees relative to a front-and-rear direction of the vehicle, and
wherein the stepped portion has an angle, defined by Equation 1, relative to the front-and-rear direction of the vehicle:
Y=(X−45)/2 Equation 1
where, Y is the angle between the stepped portion and the front-and-rear direction of the vehicle, and X is the angle between the flat portion and the front-and-rear direction of the vehicle.

3. The cover according to claim 2, wherein the stepped portion is formed to allow an end portion of the curved portion and an end portion of the flat portion, which are adjacent to each other, to be spaced apart from each other by a distance within a range from 0.32 mm to 3.00 mm.

4. The cover according to claim 2, wherein the stepped portion is formed to allow the curved portion and the flat portion, which are adjacent to each other, to be spaced apart from each other by a distance within a range from 0.30 mm to 3.00 mm in the front-and-rear direction of the vehicle.

5. The cover according to claim 2, wherein the stepped portion is formed to allow the curved portion and the flat portion, which are adjacent to each other, to be spaced apart from each other by a distance within a range from 0.00 mm to 1.03 mm in a vertical direction of the vehicle.

6. The cover according to claim 1, wherein the stepped portion is formed to have one cross-sectional shape selected among linear, curvilinear, toothed, and stepped cross-sectional shapes.

7. The cover according to claim 1, wherein the curved portion is elongated in a width direction of the vehicle, and
wherein the stepped portion is formed to contact with an upper end portion of the curved portion.

8. The cover according to claim 1, wherein the metallic-textured layer is an optical film having TiO₂ and SiO₂ alternately stacked one above another.
